(19) United States
(12) Patent Application Publication
(10) Pub. No.: US 2004/0053054 A1
(43) Pub. Date: Mar. 18, 2004

(54) Multilayer barrier polymeric films

(76) Inventors: Arthur Bobovitch, HaNegev (IL); Israel Sarid, HaNegev (IL)

Correspondence Address: Kevin D. McCarthy, Roach Brown McCarthy & Gruber, P.C., 1620 Liberty Building, 420 Main Street, Buffalo, NY, 14202, US

(21) Appl. No.: 10/601,381

(22) Filed: Jun. 23, 2003

(30) Foreign Application Priority Data
Dec. 25, 2000 (IL) 140542

(51) Int. Cl. B32B 1/00

(52) U.S. Cl. 428/409

(57) ABSTRACT

A multilayer polymer film where at least two contiguous layers are bound to each other by the cross-linking of one layer to the other layer. The additives in two contiguous layers may induce cross-linking between those layers. The polymer film may be a barrier shrink film where a polyethylene layer is bound to a contiguous EVOH layer. The multilayer polymer film is manufactured by providing in each of two contiguous layers cross-linking additives, and by irradiating the film under conditions suitable to induce cross-linking.

### FIELD OF THE INVENTION

The present invention relates to improved multilayer barrier polymer films, to polymer compositions used in the production of such films, and to a process for producing the same.

### BACKGROUND OF THE INVENTION

The use and manufacture of polymer films is well known. However, a single-layered polymer film, produced from one polymer composition, may not have the properties desired by the user of the film, or may lack additional desirable properties, e.g., impermeability to oxygen or other gases, and may need to be laminated for sealing and humidity protection. This is a problem, for instance, in the food-packaging industry.

One way to obtain desired properties is to make a multilayer or laminated film. Two or more polymer compositions are melted and laid together through coextrusion, extrusion coating or a combination thereof, to give a multilayer “tape” with either a planar or a tubular form. After cooling, such tape is reheated and stretched to give the film its final thickness and to cause “orientation”, a physical alignment of the polymer macromolecules to improve mechanical properties. Shrink films are manufactured in this way. Orientation can be achieved in various ways, for example by bubble or tenter frame techniques.

In multi-layer films, each layer of the film contributes some of the desired properties. For example, a film may have a thick outer layer to impart strength and puncture resistance, another layer that is a barrier to the passage of oxygen which might improve or increase the lifetime of a packaged food, and still another layer that improves the sealability of the film.

The properties attainable by multilayer films as described above are limited by the fact that some layers with desired properties do not bind adequately to other layers. This is often a problem with gas-barrier layers. For instance, one could consider making a barrier shrink-film by sandwiching a brittle nylon or EVOH gas-barrier layer between two polyethylene layers which are puncture resistant and sealable. However, polyethylene and nylon or EVOH do not bind to each other to form a three-layered film. Although this problem can sometimes be solved by careful formulation of polymer and additives (for instance as taught in U.S. Pat. No. 4,778,715 or 5,114,795), it is appreciated by the skilled person that it is desirable to retain as much freedom as possible in designing the formulation of each layer.

One solution to this problem is the coextrusion of a bonding-layer (also called a tie-layer) between the two layers, which do not bind to each other, as discussed in U.S. Pat. No. 4,087,587. Thus, for instance, one could coextrude a grafted maleic anhydride layer, such as Admer™ (ex Mitsui), which binds well to both nylon (EVOH) and polyethylene, between the two nylon (EVOH)-polyethylene interfaces. Illustrative of this method are U.S. Pat. No. 4,640,852, 5,759,648 or 5,895,694. The disadvantage of this solution is that the coextrusion of an extra layer is expensive, regarding required raw materials and extra equipment.

It is an object of the present invention to provide an improved multilayer polymer free of tie-layers.

It is a further object of the invention to provide new polymeric compositions which, when extruded, result in a layer with desired properties, and which have the ability to bind to contiguous layers.

Other purposes and advantages of this invention will become apparent as the description proceeds.

### SUMMARY OF THE INVENTION

Polymer compositions in contiguous layers which ordinarily do not bind to each other are made to bind by cross-linking of macromolecules in one of the said layers with macromolecules in another of said contiguous layers, due to the presence of an irradiation-sensitive, typically UV-sensitive, additive or additives in one or more of the polymer compositions of said layers. After coextrusion the tape is irradiated with UV or other suitable radiation, so that the additives cause the formation of cross links between macromolecules both within each layer and between contiguous layers, leading to binding of the contiguous layers without the need to resort to an additional bonding layer.

According to a preferred embodiment of the invention there are further provided film precursors consisting of two or more polymer compositions which ordinarily do not bind to each other when coextruded as films, but which can be bound to each other by irradiation of the coextruded tape, whereby an additive or additives present in both of the layers, can induce cross-linking of macromolecules in the contiguous layers.

According to a preferred embodiment of the invention the interlayer cross-linking eliminates the need for binding layers. The elimination of the binding layers simplifies the production process and thus substantially lowers the equipment cost and of the final product price. It also saves the costs of the binding layers. The inter-layer cross-linking enables multilayer films to be of higher quality if the total film thickness is maintained.

According to a preferred embodiment of the invention the film precursors are used to manufacture shrink film, especially barrier shrink film. This barrier shrink film is suitable, and used for, food packaging.

### BRIEF DESCRIPTION OF THE DRAWINGS

FIG. 1 is a schematic representation of the double-bubble process;

FIG. 2 is a schematic illustration of a three-layer film; and

FIG. 3 is a schematic illustration of a five-layer film.

### DETAILED DESCRIPTION OF PREFERRED EMBODIMENTS

The production of a polymer film begins with the melting of a polymer composition followed by its extrusion through a die. This extrudate is further processed, e.g., by tenter drawing or double-bubble orientation, to impart to the polymer film its desired thickness and properties.

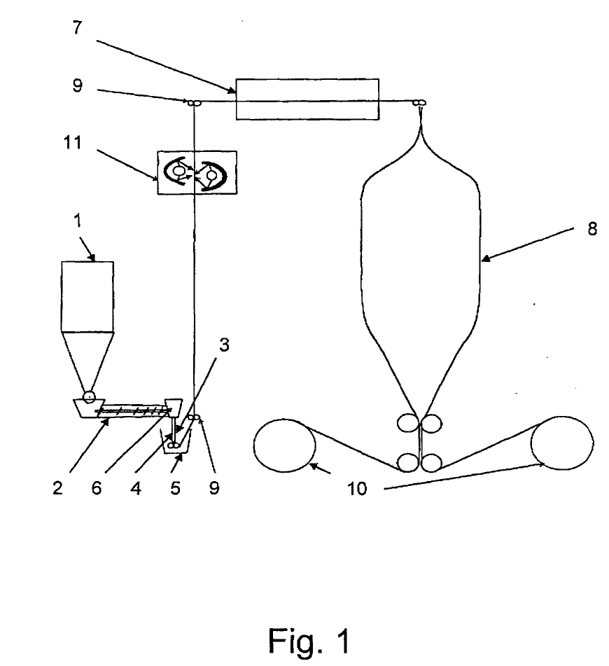

In FIG. 1 the double-bubble technique for manufacturing a film is schematically illustrated. The polymer is melted in an extruder (2) which forces it through an annular die, while air is forced coaxially through the die, to form a tube. The first bubble (3) is nipped closed at one end by the rolls (4). This is transported to an oven (7) that softens the polymer tube sufficiently to allow stretching of the tape in the second bubble (8) to enhance film properties.

By using a coextrusion die, more than one layer can be simultaneously extruded, each layer with the same or a different polymer composition to form a multilayer film. In the case of the double-bubble technique, the die will typically be a coaxial annular die where the number of passageways is determined by the number of layers desired in the produced film. When two contiguous layers are chemically compatible, that is to say when they bind sufficiently well to each other when coextruded in their molten states, the film may be processed after extrusion in the same way as a single-layer film. The multilayered film so produced can be very useful, each layer contributing different desired properties.

However, incompatible layers must be bound together using an intermediate adhesive (or tie) layer. This need is obviated by the invention, through the exploitation of interlayer cross-linking. This is achieved by dissolving appropriate concentrations of one or more cross-linking photo-initiators in both of the polymer compositions which when melted and extruded are part of the multilayer tape. Thereafter, cross-linking is initiated to achieve the desired interlayer cross-linking.

In general, cross-linking can be achieved by any suitable technique, e.g., chemical, thermal or irradiation cross-linking. The skilled person will easily identify suitable cross-linking agents for the desired type of cross-linking. For example, cross-linking can be achieved by adding one of the common agents: N-hydroysuccinimide, glutaraldehyde, tosyl chloride, divinyl sulfone etc. However, according to a preferred embodiment of this invention cross-linking is achieved by irradiation.

Cross-linking can also be achieved by irradiation with an electron beam. In this case, it is desirable to incorporate a polymeric cross-linking enhancer (PCE) as taught in U.S. Pat. No. 5,993,922. This patent teaches that PCE may consist, for example, of a polyene monomer, and a C₂-C₂₀ olefinic monomer.

As stated, according to a preferred embodiment of the present invention cross-linking is achieved by irradiating the film. After extrusion, the multilayered tape is illuminated with the appropriate radiation (e.g., with electron-beam, gamma or UV radiation) to induce interlayer cross-linking.

According to another preferred embodiment of the invention, the cross-linking additives or the cross-linking initiators are sensitive to ultraviolet radiation and an ultraviolet oven or lamp is used to illuminate the film to induce interlayer cross-linking.

According to a still preferred embodiment of the invention, the film is produced using the double-bubble technique, and the ultraviolet oven or lamp is placed before the second bubble section of the line.

All the above and other characteristics and advantages of the invention will be further explained through the following illustrative and non-limitative examples.

### EXAMPLE 1

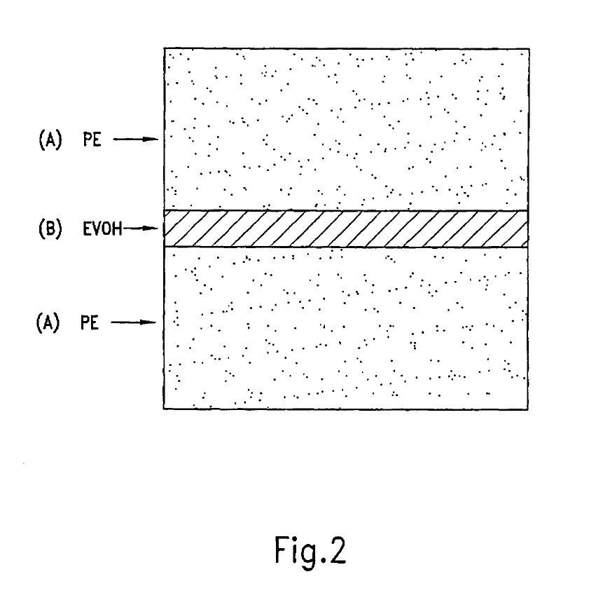

It was desired to produce a less-expensive replacement for a five-layer state-of-the-art barrier shrink-film, described in Table 1 and illustrated in FIG. 2. The photoinitiator additive, 1% BP-L was added to both the PE (polyethylene) (Dowlex 5056E ex, by Dow Chemical) and the EVOH (ethylene/vinyl alcohol) (G156B ex, By Kuraray), 10% of PCE (EPDM Vistalon 6505 ex Exxon) was added to each layer. EPDM is an ethylene-co-propylene elastomer. Unless otherwise specified, all percentages given herein are by weight. These two compositions were coextruded without tie layers (Table 2) through a coaxial annular extruder with three passageways installed in a double-bubble film production line. Before passing through the heater preceding the second bubble section of the machine, the primary tube was irradiated by exposure to ultraviolet light. The primary tube thickness was 250 microns and it was irradiated by passage through the focal planes of 3 UV lamps from each side (total of 6 lamps), at a speed of 10 m/min. The lamps used were 240 W/cm, Nordson Quadcure providing a total dosage of 0.25 J per square centimeter in the UVC spectrum (which includes the 265 nm absorption line of benzophenone). The 25 microns film was obtained by orientation of the tube, after irradiation. This irradiation causes the molecules of the cross-linking additive to cross-link within and between each of the three layers, strongly binding the two outer polyethylene layers to the central EVOH layer. The produced three-layer barrier shrink-film described in Table 2 had properties equivalent to those of the five-layer shrink-film, especially with respect to oxygen permeability, at a significantly reduced cost of production.

TABLE 1

| Layer | Function | Composition | Material |
|---|---|---|---|
| 1 | sealability and | | Polyethylene |
| | moisture barrier | | |
| 2 | tie | Admer ™ | Anhydride |
| | | | modified |
| | | | polyethylene |
| 3 | gas barrier | EVOH | EVOH |
| 4 | tie | Admer ™ | Anhydride |
| | | | modified |
| | | | polyethylene |
| 5 | sealability and | | Polyethylene |
| | moisture barrier | | |

TABLE 2

| Layer | Function | Composition |
|---|---|---|
| 1 | sealability and | Polyethylene + |
| | moisture barrier | PI + PCE |
| 2 | gas barrier | EVOH + PI + PCE |
| 3 | sealability and | Polyethylene + |
| | moisture barrier | PI + PCE |

PI—Photoinitiator
PCE—Polymer Crosslinking Enhancer

### EXAMPLE 2

It was desired to produce a replacement for a seven-layer state-of-the-art superior barrier shrink-film, described in Table 3, where EVOH (ethylene-vinyl alcohol) serves as a gas barrier (as in Example 1) and a polyamide layer supports the EVOH orientation. The photoinitiator 1% BP-L and 10% PCE (as in Example 1) were added to both the polyethylene and the EVOH. The polyamide and the two polymer mixtures were coextruded through a coaxial annular extruder with five passages installed in a double-bubble film machine. Before passing through the heater preceding the second bubble section of the machine, the tape was irradiated in an ultraviolet oven.

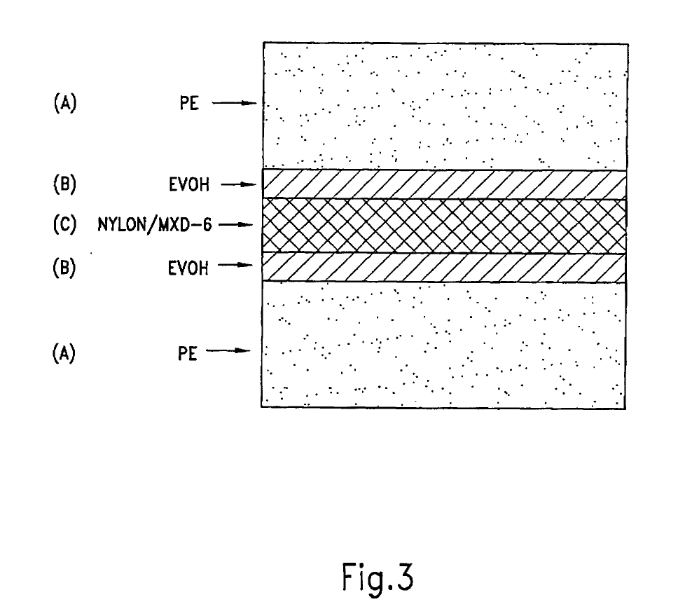

Irradiation conditions were the same as described in Example 1. This irradiation caused cross-linking within the four layers containing the photoinitiator and between the two polyethylene-EVOH interfaces, strongly binding the two outer polyethylene layers to the EVOH layers, producing the five-layer barrier shrink-film described in Table 4 and illustrated in FIG. 3. Since polyamide binds well to EVOH, this five-layer film had properties equivalent to those of the seven-layer shrink-film with respect especially to oxygen permeability, at a significantly reduced production cost.

TABLE 3

| Layer | Function | Composition | Material |
|---|---|---|---|
| 1 | sealability, | | Polyethylene |
| | moisture barrier | | |
| 2 | tie | ADMER ™ | PE/Maleic |
| | | | anhydride |
| 3 | gas barrier | EVOH | EVOH |
| 4 | gas barrier | Nylon, MXD-6 | Polyamides |
| | supports EVOH | | |
| | orientation | | |
| 5 | gas barrier | EVOH | EVOH |
| 6 | tie | ADMER ™ | PE/Maleic |
| | | | anhydride |
| 7 | sealability, | | Polyethylene |
| | moisture barrier | | |

TABLE 4

| Layer | Function | Composition | Material |
|---|---|---|---|
| 1 | sealability, | | PE + PI + PCE |
| | moisture barrier | | Polyethylene |
| 2 | gas barrier | EVOH + PI + PCE | EVOH |
| 3 | gas barrier | Nylon, MXD-6 | Polyamides |
| | supports EVOH | | |
| | orientation | | |
| 4 | gas barrier | EVOH + PI + PCE | EVOH |
| 5 | sealabilty, | PE + PI + PCE | Polyethylene |
| | moisture barrier | | |

### EXAMPLE 3

This example demonstrates the important role of PCE presence and the irradiation effect. Three-layer systems (A/B/A) were prepared:

The first system contained polyethylene as layers A and EVOH as layer B. The polyethylene and the EVOH were the same as in Example 1.1% PB-L was added then to each layer. PCE was not used.

System 2 had the same structure as System 1, but 10% PCE (EPDM) was added to each layer, as in Example 1.

The above systems were irradiated by UV. The primary tube thickness was 450 microns and it was irradiated by passing through the focal planes of 3 UV lamps from each side (total of 6 lamps), at a speed of 12 m/min. The lamps used were 240 W/cm, Fusion Inc., H bulbs, providing a total dosage of 0.25 J per square centimeter in the UVC spectrum (which includes the 265 nm absorption line of benzophenone).

The delamination force, i.e., the force required to separate the layers, is measured on the primary tube and summarized in Table 5 (results are in Newton/25 mm).

Delamination Force

| System No. | Without Irradiation | Post Irradiation |
|---|---|---|
| 1 | 0.25 | 2 |
| 2 | 0.5 | 15* |

*No break in the interface. The break occurred in the PE layer.

While embodiments of the invention have been described by way of illustration, it will be understood that the invention can be carried out by persons skilled in the art with many modifications, variations and adaptations, without departing from its spirit or exceeding the scope of the claims.

1. A multilayer polymer film, where at least two contiguous layers are bound to each other by cross-linking of one layer to the other layer.

2. A film according to claim 1, wherein the cross-linking between two contiguous layers is the result of irradiation of cross-linking additives in both said layers.

3. A multilayer film according to claim 1 or 2, wherein the polymer film is a barrier shrink film where a polyethylene layer is bound to a contiguous EVOH layer.

4. A process for manufacturing a multilayer polymer film, comprising providing in each of two contiguous layers cross-linking additives, and irradiating the film in conditions suitable to induce cross-linking between them.

5. A process according to claim 4, comprising providing in a plurality of pairs of contiguous layers cross-linking additives, and irradiating the film under conditions suitable to induce cross-linking between respective members of each of said pairs.

6. A process according to claim 4, wherein the multilayer polymer film is manufactured using the double-bubble process or the Tenter process.

7. A process according to any one of the preceding claims, wherein the radiation is ultraviolet radiation at wavelengths to which the cross-linking additives are sensitive.

8. A process according to any one of the preceding claims, wherein the multilayer polymer film to be produced is a barrier shrink film where a polyethylene layer is to be bound to a contiguous layer of EVOH/PE blend or EVOH layer.
